(19) United States
(12) Patent Application Publication
(10) Pub. No.: US 2008/0147994 A1
(43) Pub. Date: Jun. 19, 2008

(54) COMMAND SCHEDULING METHOD AND APPARATUS OF VIRTUAL FILE SYSTEM EMBODIED IN NONVOLATILE DATA STORAGE DEVICE

(75) Inventors: Seong-hun JEONG, Suwon-si (KR); Sung-hwan BAE, Seoul (KR); Jang-hwan KIM, Suwon-si (KR); Nam-hyun YUN, Seoul (KR); Young-bong KIM, Seoul (KR); Houng-sog MIN, Ansan-si (KR); Dong-woo LEE, Suwon-si (KR); Shin-wook KANG, Hwaseong-si (KR); Hyang-suk PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/958,815

(22) Filed: Dec. 18, 2007

(30) Foreign Application Priority Data
Dec. 18, 2006 (KR) 10-2006-0129661

(51) Int. Cl. G06F 12/08

(52) U.S. Cl. 711/154; 711/E12.016

(57) ABSTRACT

A command scheduling method and apparatus for reducing the complexity of a virtual file system embodied in a nonvolatile data storage device and performing efficient interleaving by setting a preparation phase of a command schedule in the virtual file system embodied in the nonvolatile data storage device is provided. The method includes setting a preparation phase in which a plurality of metadata commands for data management are executed, and if the plurality of metadata commands are completely executed in the preparation phase, executing data read/write commands. Accordingly, by simplifying the scheduling structure of the virtual file system (FTL), code size and resource use can be reduced. In addition, by performing exact interleaving, burst data transmission between a host and a memory storage device can be achieved even without using a large capacity buffer.

### CROSS-REFERENCE TO RELATED PATENT APPLICATION

This application claims priority from Korean Patent Application No. 10-2006-0129661, filed on Dec. 18, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a command scheduling method and apparatus, and more particularly, to a command scheduling method and apparatus for reducing the complexity of a virtual file system embodied in a nonvolatile data storage device, and performing efficient interleaving by setting a preparation phase of a command schedule in the virtual file system embodied in the nonvolatile data storage device.

2. Description of the Related Art

Recent multimedia devices, including mobile devices, store a very large amount of multimedia data, such as MP3 sound and moving pictures. They thus require data storage devices which provide a very large storage space and can read and write data at a high rate.

FIG. 1 shows an N-channel/4-way hardware architecture using flash memory.

Flash memory is a nonvolatile data storage device used in various mobile devices due to its low power consumption, miniaturization, low heat, and high stability. The storage space of a single flash memory is also quickly increasing to meet users' demands.

However, flash memory typically has a slow programming (write) speed. To overcome this and perform high-speed data input/output, various hardware architectures have been suggested for flash memory storage devices.

Referring to FIG. 1, a flash memory controller 110 is connected to 4 flash memories 120 via a single channel. In order to increase the storage capacity and data input/output performance, flash memory storage devices use a plurality of flash memory chips as illustrated in FIG. 1.

Read/write of flash memories includes two operations: i) reading/writing data from/to a memory cell; and ii) inputting/outputting data from/to the flash memory controller 110. Thus, a controller in a flash memory storage device is connected to a plurality of flash memory chips via a single data input/output channel, and inputs/outputs data using interleaving. According to a general flash memory standard, since a single channel makes it difficult to expect an increase of performance when 4-5 flash memory chips are used, the 4-way architecture is usually used, in which address distribution is achieved in a power of two.

FIG. 2 is a timing diagram of a write operation of 4 flash memories in the single channel illustrated in FIG. 1. FIG. 3 is a timing diagram of a single page write operation illustrated in FIG. 2.

As illustrated in FIG. 3, when a page unit of 2 KB is used in a single page write operation 210, a page setup time is 51.2 μs (a setup time of 1 byte is 25 ns), and a programming time is 200 μs. In order to compensate for a relatively slow programming time, bulk data is divided and stored in the 4 flash memories 120 of a single channel illustrated in FIG. 1. According to the related art, a high-speed write operation using interleaving as illustrated in FIG. 2 is performed to minimize a wait time of a controller by performing setup in other flash memories in an idle state while programming is performed in a flash memory.

FIG. 4 shows a bit-width extension hardware architecture using flash memory.

A large capacity flash memory storage device may use more than 5 flash memory chips, and in this case can use a bit-width extension architecture or a multi-channel architecture. The multi-channel architecture can be an extension of the 1-channel/x-way architecture described above, and the bit-width extension architecture is a method of simultaneously transmitting data by connecting more than 2 flash memory chips. In this case, connected flash memory chips must simultaneously perform read/write at the same address.

In general, for a flash memory, read/write is performed on a page basis, and in order to rewrite data for update, an erase operation must be first performed in block units, each of which include a plurality pages. This characteristic is different from that of general storage devices, and thus, in order to have compatibility with an existing file system, a flash memory storage device is managed using specific software (virtual file system) called a Flash Translation Layer (FTL). The virtual file system for compatibility with a file system can also be applied to other nonvolatile data storage devices, and thus the description below can be applied to all nonvolatile data storage devices.

The FTL generally uses various kinds of metadata, such as an address mapping table, free block information, bad block information, and the like, from the complex hardware architectures described above, and most metadata is stored in a flash memory. The metadata of the FTL is independently stored in device or plain units each corresponding to a range covered by a copyback command of a flash memory. This allows efficient garbage collection, which is an important job of the FTL. A flash memory storage device having a complex architecture using a plurality of flash memory chips has independent metadata proportional to the number of flash memory chips.

FIG. 5 is a timing diagram of a command sequence of an FTL according to a write request command using a single flash memory.

In the hardware architectures described above, the FTL transmits various commands to each flash memory in response to a read/write request of a file system. In FIG. 5, if it is assumed that a storage device using a single flash memory chip is used, commands transmitted from the FTL to hardware in response to a data write request 510 of a file system are mixed with metadata commands 520 and 540, such as a map table read/update command, a block erase command, and a block merge command 521, and data commands 530 and 550 for inputting/outputting user data.

As described above, a flash memory storage device using a plurality of flash memory chips for a high-speed data input/output has a plurality of independent pieces of metadata on a flash memory chip device or channel basis. Thus, in this structure, the FTL transmits a different command to each metadata in response to a data read/write request of the file system. That is, each independent FTL metadata has a different metadata command set and a different processing time.

Thus, a command issue time with respect to user data differs between the FTL metadata. Since each FTL management unit has a different command schedule (job schedule), an increase of the number of FTL management units causes an increase of the complexity of the FTL, and a large capacity buffer is necessary due to the difference between issue times to the user data. The increase of complexity of the FTL causes an increase of the code size of the FTL, an increase of memory usage, and an increase of Central Processing Unit (CPU) load, resulting in an increased resource use. An increase of the FTL processing amount may cause a delay for each command issued, difficulty of burst data transmission between a host and a storage device due to congestion of user data read/write commands, and may negate the performance improvement of interleaving. These problems result in a decrease of data input/output performance of a flash memory storage device.

### SUMMARY OF THE INVENTION

The present invention provides a command scheduling method and apparatus for reducing the complexity of a virtual file system embodied in a nonvolatile data storage device and performing efficient interleaving by setting a preparation phase of a command schedule in the virtual file system embodied in the nonvolatile data storage device.

According to an aspect of the present invention, there is provided a command scheduling method of a virtual file system embodied in a nonvolatile data storage device, the method comprising: setting a preparation phase in which a plurality of metadata commands for data management are executed; and if the plurality of metadata commands are completely executed in the preparation phase, executing data read/write commands.

The method may further comprise executing the plurality of metadata commands in the set preparation phase, wherein the plurality of metadata commands are executed in a unit managed by the virtual file system.

The setting of the preparation phase may further comprise: calculating execution times of preparation jobs for the data read/write commands in the unit managed by the virtual file system; and setting the preparation phase based on the longest of the calculated execution times.

The preparation jobs for the data read/write commands and the plurality of metadata commands may be preparation jobs of the virtual file system based on the types of the data read/write commands, and each of the preparation jobs of the virtual file system may comprise at least one of metadata read/update, garbage collection, map table read/update, and unit erase.

The executing of the data read/write commands may comprise executing the data read/write commands together after the set preparation phase, and the data read/write commands executed together may be executed in the data read/write order using an interleaving method.

The nonvolatile data storage device may comprise flash memories, the virtual file system may be a FTL, and a unit managed by the FTL may be a device unit of the flash memories or a channel unit using the flash memories.

According to another aspect of the present invention, there is provided an extended command scheduling method of a virtual file system embodied in a nonvolatile data storage device, the method comprising: setting a preparation phase in which a plurality of metadata commands for data management are executed; executing metadata commands of the next preparation phase during idle times in the set preparation phase; and if the plurality of metadata commands and the metadata commands of the next preparation phase are completely executed in the set preparation phase, executing data read/write commands.

The method may further comprise executing the plurality of metadata commands in the set preparation phase, wherein the plurality of metadata commands and the metadata commands of the next preparation phase are executed in a unit managed by the virtual file system.

The setting of the preparation phase may further comprise: calculating execution times of preparation jobs for the data read/write commands in a unit managed by the virtual file system; and setting the preparation phase based on the longest of the calculated execution times.

The idle times in the set preparation phase may be calculated by subtracting an execution time of each of the preparation jobs in a unit managed by the virtual file system from an execution time of the set preparation phase, and the executing of the metadata commands of the next preparation phase during the idle times in the set preparation phase may comprise calculating execution times of the metadata commands of the next preparation phase in a unit managed by the virtual file system and respectively assigning the idle times to the metadata commands of the next preparation phase.

The preparation jobs for the data read/write commands, the plurality of metadata commands, and the metadata commands of the next preparation phase may comprise at least one of metadata read/update, garbage collection, map table read/update, and unit erase based on types of the data read/write commands.

The executing of the data read/write commands may comprise executing the data read/write commands together after the set preparation phase, and the data read/write commands executed together may be executed in the data read/write order using an interleaving method.

The nonvolatile data storage device may comprise flash memories, the virtual file system may be a FTL, and a unit managed by the FTL may be a device unit of the flash memories or a channel unit using the flash memories.

According to another aspect of the present invention, there is provided a command scheduling method of a FTL embodied in flash memories, the method comprising: calculating execution times of preparation jobs for data read/write commands in a unit managed by the FTL; setting a preparation phase based on the longest execution time from among the calculated execution times; executing a plurality of metadata commands for data management in the unit managed by the FTL in the preparation phase; and executing the data read/write commands together after the set preparation phase.

The unit managed by the FTL may be a device unit of the flash memories or a channel unit using the flash memories, and the preparation jobs for the data read/write commands and the plurality of metadata commands may comprise at least one of metadata read/update, garbage collection, map table read/update, and unit erase.

The executing of the data read/write commands together may comprise may be executed in the data read/write order using an interleaving method.

The method may further comprise: calculating idle times by subtracting an execution time of each of the preparation jobs in a unit managed by the FTL from an execution time of the set preparation phase; and executing metadata commands of the next preparation phase during the calculated idle times in the unit managed by the FTL, and the executing of the metadata commands of the next preparation phase during the calculated idle times in the unit managed by the FTL may comprise calculating execution times of the metadata commands of the next preparation phase in the unit managed by the FTL and respectively assigning the idle times to the metadata commands of the next preparation phase.

According to another aspect of the present invention, there is provided a command scheduler of a virtual file system embodied in a nonvolatile data storage device, the command scheduler comprises: an execution time calculator calculating execution times of preparation jobs for data read/write commands in a unit managed by the virtual file system; a first controller controlling a plurality of metadata commands for data management to be executed by setting a preparation phase based on the longest of the calculated execution times; and a second controller controlling the data read/write commands to be executed together after the set preparation phase.

The first controller may further comprise: an idle time calculator calculating idle times by subtracting an execution time of each of the preparation jobs in a unit managed by the virtual file system from an execution time of the set preparation phase; and an extra job module executing metadata commands of the next preparation phase during the calculated idle times in the unit managed by the virtual file system.

According to another aspect of the present invention, there is provided a computer readable recording medium storing a computer readable program for executing the scheduling method.

### BRIEF DESCRIPTION OF THE DRAWINGS

The above and other features of the present invention will become more apparent by describing in detail exemplary embodiments thereof with reference to the attached drawings in which:

FIG. 1 shows an N-channel/4-way hardware architecture using flash memory;

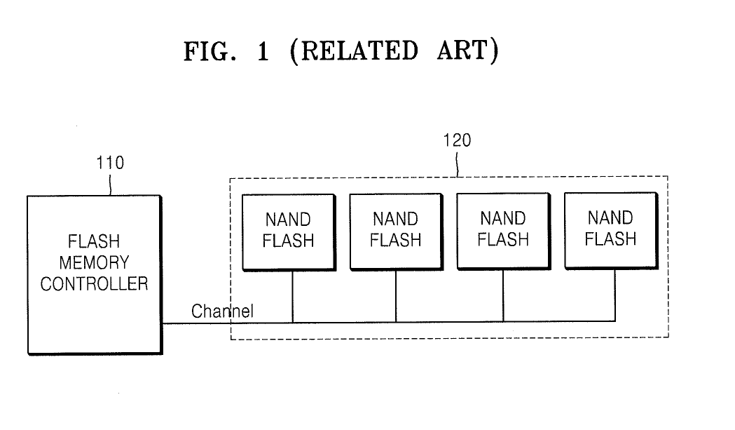

FIG. 2 is a timing diagram of a write operation of 4 flash memories in a single channel illustrated in FIG. 1;

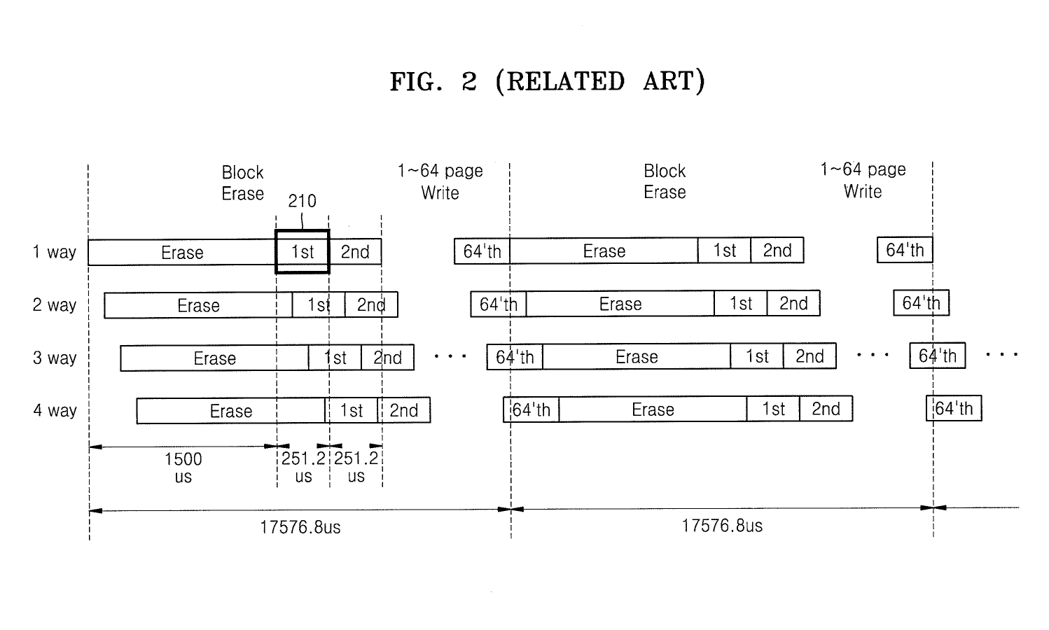

FIG. 3 is a timing diagram of a single page write operation illustrated in FIG. 2;

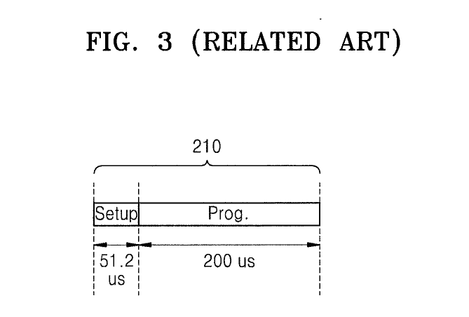

FIG. 4 shows a bit-width extension hardware architecture using flash memory;

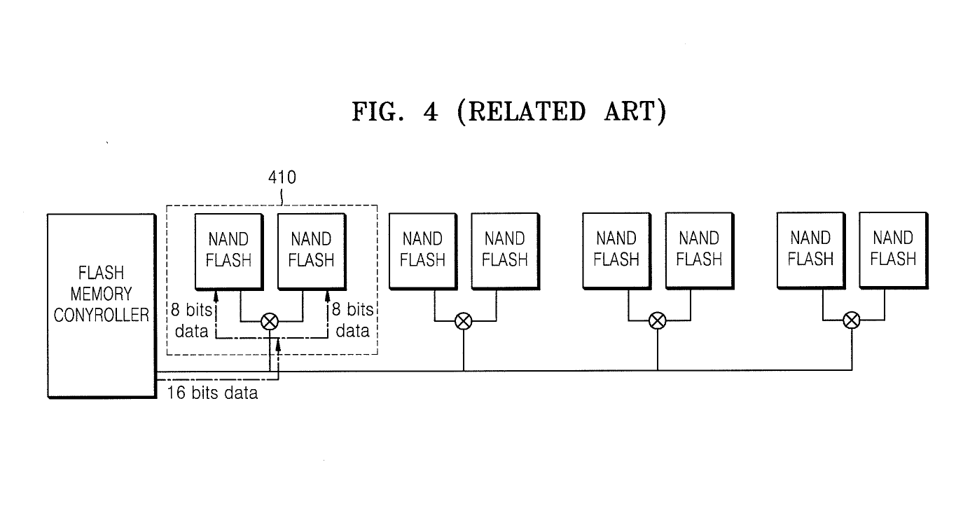

FIG. 5 is a timing diagram of a command sequence of a FTL according to a write request command using a single flash memory;

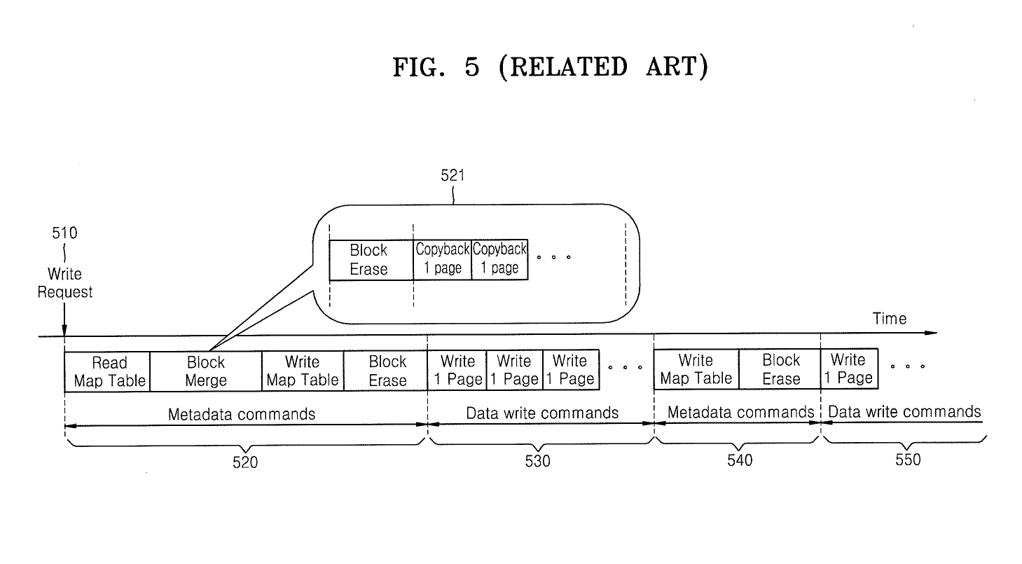

FIG. 6 is a flowchart of a command scheduling method of a virtual file system embodied in a nonvolatile data storage device according to an exemplary embodiment of the present invention;

FIG. 7 is a timing diagram of a command scheduling method of a virtual file system embodied in a nonvolatile data storage device according to an exemplary embodiment of the present invention;

FIG. 8 is a flowchart of an extended command scheduling method of a virtual file system embodied in a nonvolatile data storage device according to an exemplary embodiment of the present invention;

FIG. 9 is a timing diagram of an extended command scheduling method of a virtual file system embodied in a nonvolatile data storage device according to another exemplary embodiment of the present invention; and

FIG. 10 is a block diagram of a command scheduling apparatus of a virtual file system embodied in a nonvolatile data storage device according to another exemplary embodiment of the present invention.

### DETAILED DESCRIPTION OF EXEMPLARY EMBODIMENTS OF THE INVENTION

The present invention will now be described in detail by explaining exemplary embodiments of the invention with reference to the attached drawings. Although flash memories are described hereinafter for exemplary purposes, the invention can be applied to all nonvolatile data storage devices.

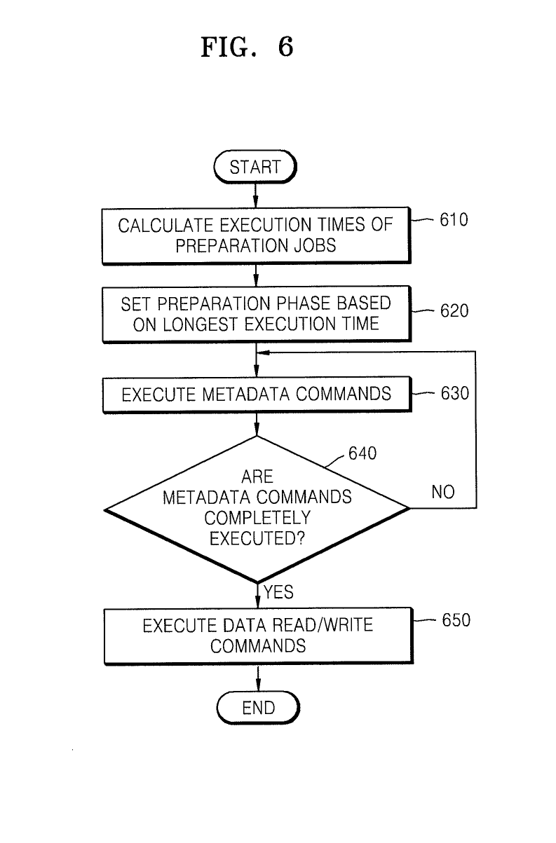

FIG. 6 is a flowchart of a command scheduling method of a virtual file system embodied in a nonvolatile data storage device according to an exemplary embodiment of the present invention.

Referring to FIG. 6, in order to set a preparation phase, execution times of preparation jobs for data read/write commands, i.e., data read commands or data write commands, or both commands, are calculated by a unit managed by the virtual file system (or a FTL) in operation 610. Since the FTL manages a plurality of independent pieces of metadata in a memory chip device unit or a channel unit using a plurality of devices (x-way), the execution times of preparation jobs for data read/write commands are calculated by the management unit. In order to execute user data read/write commands, preparation operations (preparation jobs) are necessary according to types of data read/write commands in the management unit. For example, various FTL metadata commands, such as map table read/update, i.e., map table read or map table update, or both, unit (block) erase, and garbage collection (merge, switch, and compaction), are executed before the data read/write commands are executed. The FTL calculates the execution times of the preparation jobs in a device unit (or channel unit).

The preparation phase is set based on the longest of the calculated execution times, in operation 620. In other words, the longest calculated execution time of the preparation jobs including other devices is set as an execution time of the preparation phase. During the execution time of the preparation phase, various FTL metadata commands described above, such as map table read/update, block erase, block merge, and the like, are executed in operation 630, and the data read/write commands are not transmitted for command schedule management.

If the metadata commands of the preparation phase are completely executed in operation 640, i.e. if the preparation phase ends, the FTL executes the user data read/write commands together in operation 650. The duration in which the user data read/write commands are executed is set as a data phase, as compared to the preparation phase. Since the data read/write commands are executed together, user data divided and stored in a plurality of memory chips (devices) or channels can be processed at high speed using interleaving. In this manner, a read/write request of a host is completed by repeatedly performing at least one pair of a preparation phase and a data phase.

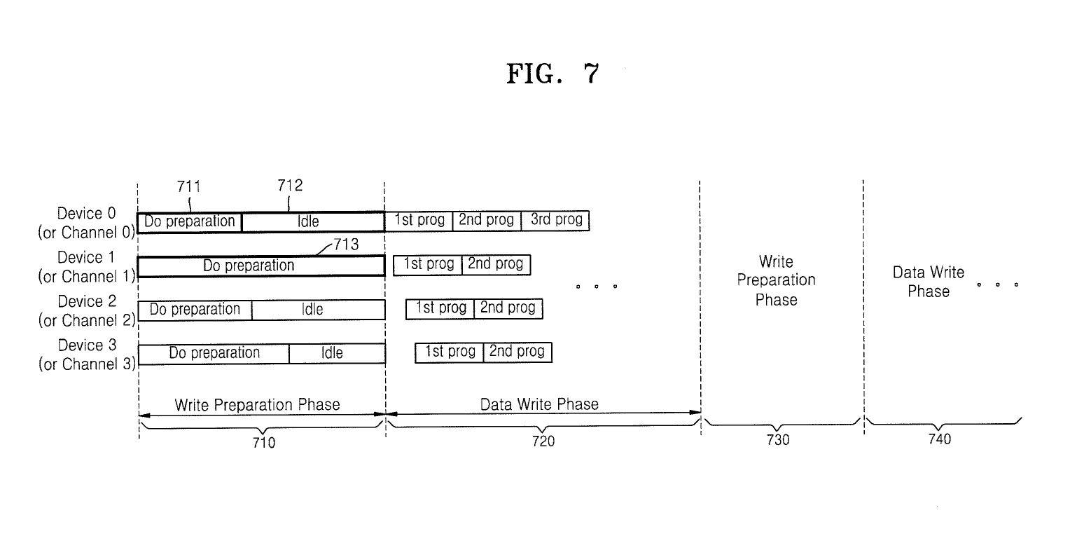

FIG. 7 is a timing diagram of a command scheduling method of a virtual file system embodied in a nonvolatile data storage device according to an exemplary embodiment of the present invention.

Referring to FIG. 7, it is assumed that metadata of an FTL is managed on a 4-flash memory chip or 4-channel basis, and preparation phases 710 and 730 each include commands (‘do preparation’) 711 for executing various jobs (map table read/write, garbage collection, block erase, and the like) according to the situation. Each preparation phase 710 or 730 can be performed in a logical block unit or read/write request unit of the virtual file system.

In addition, each of four FTL management units performs a different preparation job and has a different execution time. If a preparation job 713 of a device 1 requiring the longest execution time is completed, i.e. if the preparation phase 710 or 730 ends, a data phase 720 or 740 starts. In the data phase 720 or 740, data read/write commands are executed in the order of user data input from a host (or stored in a buffer), and the four FTL management units can read/write with correct interleaving.

By simply dividing a command schedule into the preparation phases 710 and 730 and the data phases 720 and 740, theoretical performance of an interleaving method can be effectively shown, and since a user data input/output sequence matches a user data command sequence of a command schedule, burst data transmission between FTLs can be achieved easily.

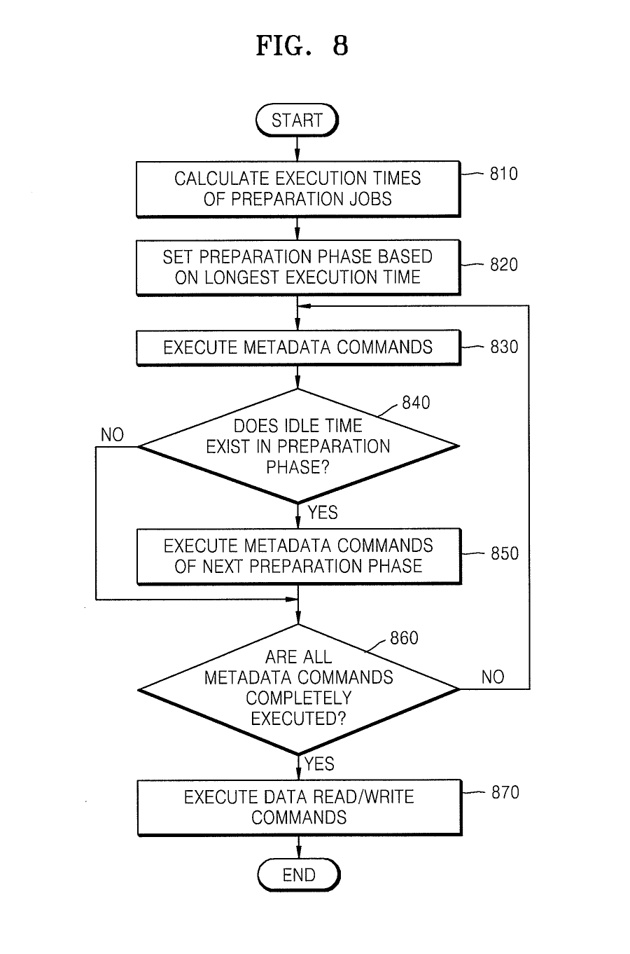

FIG. 8 is a flowchart of an extended command scheduling method of a virtual file system embodied in a nonvolatile data storage device according to an exemplary embodiment of the present invention.

Referring to FIG. 8, as in FIG. 6, execution times of preparation jobs for data read/write commands are calculated by a management unit of the virtual file system in operation 810. Since metadata used for the preparation jobs are independent of each other, the execution times of the preparation jobs are calculated individually. Thus, a preparation phase is set based on the longest of the calculated execution times, in operation 820, and during an execution time of the preparation phase, various metadata commands are executed in operation 830.

In this case, all the devices except for the one calculated by the management unit (e.g. a device unit) to have the longest execution time, i.e. a device continuously executing a preparation job during all the execution time of the preparation phase, secure an idle time after their metadata commands (preparation jobs) are completed. Each device's idle time can be calculated by subtracting the execution time of that device's preparation job from the execution time of the preparation phase. The FTL can use the idle times as a chance to execute another job instead of wasting the idle times as waiting time. Thus, in the extended command scheduling method, preparation jobs needed for the next preparation phase are performed in advance during the idle times.

Since the preparation jobs needed for the next preparation phase, i.e. metadata commands, are typically a map table read job, a garbage collection job for securing free blocks, a block erase job as a pre-processing job for a data write, and the like, by calculating the execution times of the preparation jobs in advance, a portion of the preparation jobs can be performed in the idle times. Since the idle times in each preparation phase can be saved through this process, the processing time of a single read/write request is reduced. Furthermore, in high-speed data transmission in which a plurality of requests are continuously received, the entire data input/output processing performance can be considerably increased.

As described above, it is determined in operation 840 whether an idle time exists in the preparation phase, and if so, the metadata commands of the next preparation phase are executed in operation 850. If all the metadata commands are completely executed in operation 860, i.e. if the preparation phase ends, user data read/write commands are executed in operation 870. In this case, since the data read/write commands are executed together (in a data phase) as illustrated in FIG. 6, user data divided and stored can be processed at a high speed using an exact interleaving method.

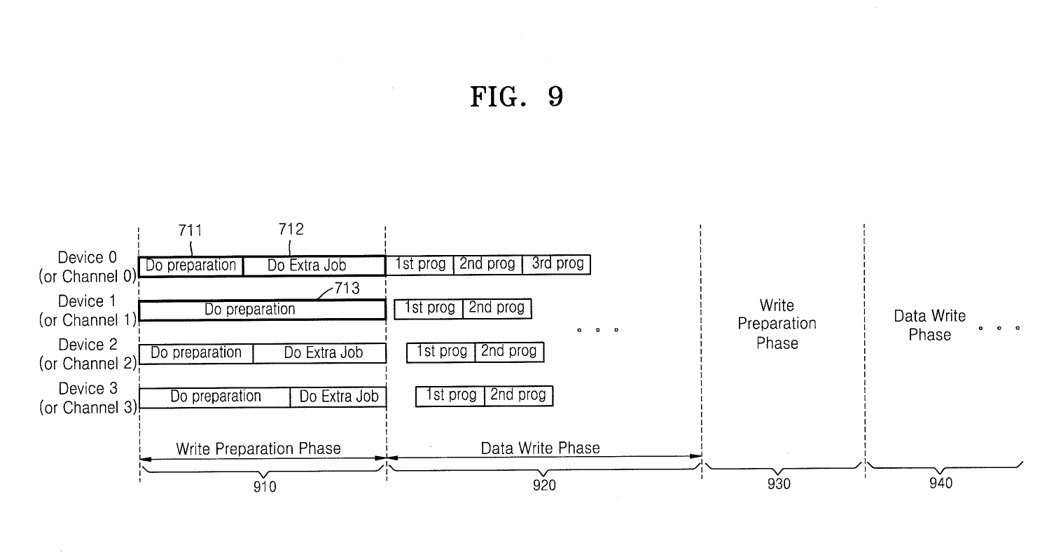

FIG. 9 is a timing diagram of an extended command scheduling method of a virtual file system embodied in a nonvolatile data storage device according to another embodiment of the present invention.

In FIG. 7, the idle times 712 occur due to the different execution times of the preparation jobs in the FTL management unit. In FIG. 9, by predicting jobs to be performed in the next preparation phase in advance, and performing a portion of the jobs to be performed in the next preparation phase (extra jobs) during the idle times 712, the idle times 712 are minimized, resulting in an increase of read/write performance of the nonvolatile data storage device. In general, the extra jobs added during the idle times 712 are, for example, a block erase job, a map table read job of an address adjacent to the address of a current job, a garbage collection job for collecting free blocks, and the like. The extra jobs added during the idle times 712 can reduce the average execution time of the total preparation phase, resulting in a decrease of a read/write processing time of the nonvolatile data storage device. Furthermore, a designer may achieve higher data input/output performance according to the intended use of the nonvolatile data storage device by establishing various extra job policies.

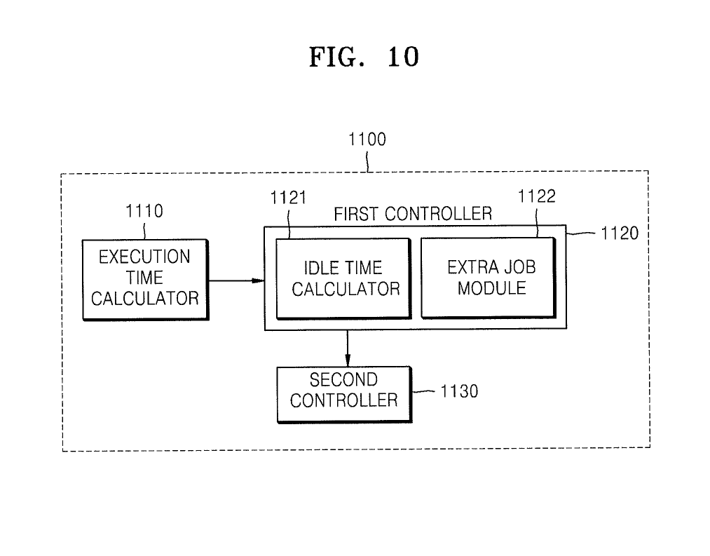

FIG. 10 is a block diagram of a command scheduling apparatus of a virtual file system embodied in a nonvolatile data storage device according to another exemplary embodiment of the present invention.

Referring to FIG. 10, an execution time calculator 1110 calculates execution times of preparation jobs for data read/write commands in a unit managed by the virtual file system (FTL).

The first controller 1120 controls a plurality of metadata commands for data management to be executed by setting a preparation phase based on the longest of the execution times calculated by the execution time calculator 1110. The first controller 1120 may further include an idle time calculator 1121 calculating each idle time by subtracting the execution time of each of the preparation jobs in the unit managed by the virtual file system from the execution time of the set preparation phase, and an extra job module 1122 executing metadata commands of the next preparation phase during the idle times in the unit managed by the virtual file system.

If the metadata commands are completed by the first controller 1120, a second controller 1130 controls the data read/write commands to be executed together after the set preparation phase.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the present invention, when a plurality of flash memories are used for large capacity high-speed data input/output processing of a memory storage device, by simplifying the structure of a virtual file system (FTL) using a command scheduling method, code size and resource use can be reduced. In addition, since data input from a host can be sequentially recorded in a data phase, correct interleaving can be expected, and burst data transmission between the host and the memory storage device can be achieved even without using a large capacity buffer.

In addition, since jobs needed in the next preparation phase can be performed in advance as extra jobs added during idle times in a preparation phase using an extended command scheduling method, the average execution time of the total preparation phase is reduced, resulting in an increase of the data input/output performance of a storage device.

While this invention has been particularly shown and described with reference to exemplary embodiments thereof, it will be understood by those skilled in the art that various changes in form and detail may be made therein without departing from the spirit and scope of the invention as defined by the appended claims. The exemplary embodiments should be considered in a descriptive sense only, and not for purposes of limitation. Therefore, the scope of the invention is defined not by the detailed description of the exemplary embodiments of the invention but by the appended claims, and all differences within the scope will be construed as being included in the present invention.

What is claimed is:

1. A command scheduling method of a virtual file system embodied in a nonvolatile data storage device, the method comprising:
setting a preparation phase in which a plurality of metadata commands for data management are executed; and
when execution of all of the metadata commands of the plurality of metadata commands is complete in the preparation phase, executing at least one of a data read command and a data write command.

2. The method of claim 1, wherein the setting of the preparation phase comprises:
calculating execution times of a plurality of preparation jobs for the data read/write commands in a unit managed by the virtual file system; and
setting the preparation phase based on a first preparation job having a longest of the calculated execution times.

3. The method of claim 2, further comprising executing the plurality of metadata commands in the set preparation phase,
wherein the plurality of metadata commands are executed in the unit managed by the virtual file system.

4. The method of claim 3, wherein the plurality of preparation jobs for the data read/write commands and the plurality of metadata commands are preparation jobs of the virtual file system based on types of the data read/write commands.

5. The method of claim 4, wherein each of the plurality of preparation jobs of the virtual file system comprises at least corresponding one of metadata read, metadata update, garbage collection, map table read, map table update and unit erase.

6. The method of claim 1, wherein the executing of the data read/write commands comprises executing the data read/write commands together after the set preparation phase.

7. The method of claim 6, wherein the data read/write commands executed together are executed in a data read/write order using an interleaving method.

8. The method of claim 7, wherein the nonvolatile data storage device comprises flash memories, the virtual file system is a Flash Translation Layer (FTL), and a unit managed by the FTL is a device unit of the flash memories or a channel unit using the flash memories.

9. An extended command scheduling method of a virtual file system embodied in a nonvolatile data storage device, the method comprising:
setting a first preparation phase in which a first set of metadata commands for data management are executed;
executing a second set of metadata commands of a second preparation phase that is after the first preparation phase during idle times in the first preparation phase; and
if the first set of metadata commands and the second set of metadata commands are completely executed in the first preparation phase, executing at least one of a data read command and a data write command.

10. The method of claim 9, wherein the setting of the first preparation phase comprises:
calculating execution times of a plurality of preparation jobs for the data read/write commands in a unit managed by the virtual file system; and
setting the first preparation phase based on a first preparation job having a longest of the calculated execution times.

11. The method of claim 10, further comprising executing the first set of metadata commands in the first preparation phase,
wherein the first metadata commands and the second metadata commands are executed in a unit managed by the virtual file system.

12. The method of claim 11, wherein the idle times in the first preparation phase are calculated by subtracting an execution time of each of the plurality of preparation jobs in a unit managed by the virtual file system from an execution time of the first preparation phase.

13. The method of claim 12, wherein the executing of the second set of metadata commands during the idle times in the first preparation phase comprises calculating execution times of the second set of metadata commands in a unit managed by the virtual file system and respectively assigning the idle times to the second set of metadata commands.

14. The method of claim 13, wherein the plurality of preparation jobs for the data read/write commands, the first set of metadata commands, and the second set of metadata commands comprise at least two of metadata read, metadata update garbage collection, map table read, map table update and unit erase based on types of the data read/write commands.

15. The method of claim 9, wherein the executing of the data read/write commands comprises executing the data read/write commands together after the first preparation phase.

16. The method of claim 15, wherein the data read/write commands executed together are executed in a data read/write order using an interleaving method.

17. The method of claim 16, wherein the nonvolatile data storage device comprises flash memories, the virtual file system is a Flash Translation Layer (FTL), and a unit managed by the FTL is a device unit of the flash memories or a channel unit using the flash memories.

18. A command scheduling method of a Flash Translation Layer (FTL) embodied in flash memories, the method comprising:
calculating execution times of a plurality of preparation jobs for data read/write commands in a unit managed by the FTL;
setting a first preparation phase based on a first preparation job of the plurality of preparation jobs having a longest of the calculated execution times;
executing a first set of metadata commands for data management in the unit managed by the FTL in the first preparation phase; and
executing at least one of the data read commands and data write commands together after the first preparation phase.

19. The method of claim 18, wherein the unit managed by the FTL is a device unit of the flash memories or a channel unit using the flash memories.

20. The method of claim 19, wherein the plurality of preparation jobs for the data read/write commands and the first set of metadata commands comprise at least two of metadata read/update, garbage collection, map table read/update, and unit erase.

21. The method of claim 18, further comprising:
calculating idle times by subtracting an execution time of each of the plurality of preparation jobs in a unit managed by the FTL from an execution time of the first preparation phase; and
executing a second set of metadata commands of a second preparation phase during the calculated idle times in the unit managed by the FTL.

22. The method of claim 21, wherein the executing of the second set of metadata commands during the calculated idle times in the unit managed by the FTL comprises calculating execution times of the second set of metadata commands in the unit managed by the FTL and respectively assigning the idle times to the second set of metadata commands.

23. The method of claim 18, wherein the data read/write commands executed together are executed in a data read/write order using an interleaving method.

24. A command scheduler of a virtual file system embodied in a nonvolatile data storage device, the command scheduler comprising:
an execution time calculator that calculates execution times of a plurality of preparation jobs for data read/write commands in a unit managed by the virtual file system;
a first controller that controls a first set of metadata commands for data management to be executed by setting a first preparation phase based on a first preparation job of the plurality of preparation jobs having a longest of the calculated execution times; and
a second controller that controls at least one of the data read commands and data write commands to be executed together after the first preparation phase.

25. The apparatus of claim 24, wherein the first controller further comprises:
an idle time calculator that calculates idle times by subtracting an execution time of each of the plurality of preparation jobs in a unit managed by the virtual file system from an execution time of the first preparation phase; and
an extra job module executing a second set of metadata commands of a second preparation phase during the calculated idle times in the unit managed by the virtual file system.

26. A computer readable recording medium storing a computer readable program that executes a command scheduling method of a virtual file system embodied in a nonvolatile data storage device, the method comprising:
setting a preparation phase in which a plurality of metadata commands for data management are executed; and
when execution of all of the metadata commands of the plurality of metadata commands is complete in the preparation phase, executing at least one of a data read command and a data write command.

27. A computer readable recording medium storing a computer readable program that executes an extended command scheduling method of a virtual file system embodied in a nonvolatile data storage device, the method comprising:
setting a first preparation phase in which a first set of metadata commands for data management are executed;
executing a second set of metadata commands of a second preparation phase that is after the first preparation phase during idle times in the first preparation phase; and
if the first set of metadata commands and the second set of metadata commands are completely executed in the first preparation phase, executing at least one of a data read command and a data write command.

28. A computer readable recording medium storing a computer readable program that executes a command scheduling method of a Flash Translation Layer (FTL) embodied in flash memories, the method comprising:
calculating execution times of a plurality of preparation jobs for data read/write commands in a unit managed by the FTL;
setting a first preparation phase based on a first preparation job of the plurality of preparation jobs having a longest of the calculated execution times;
executing a first set of metadata commands for data management in the unit managed by the FTL in the first preparation phase; and
executing at least one of the data read commands and data write commands together after the first preparation phase.
